(19) United States
(12) Patent Application Publication
(10) Pub. No.: US 2026/0218090 A1
(43) Pub. Date: Jul. 30, 2026

(54) A LOW-TEMPERATURE, CAUSTIC DISHWARE SANITIZING METHOD

(71) Applicant: ECOLAB USA INC., Saint Paul, MN (US)

(72) Inventors: Zhenbo Gao, Shanghai (CN); Kai Qiu, SHANGHAI (CN); Xin Lu, SHANGHAI (CN)

(21) Appl. No.: 19/144,760

(22) PCT Filed: Feb. 8, 2023
(86) PCT No.: PCT/CN2023/074917

§ 371 Date: Jun. 30, 2025

(51) Int. Cl. C11D 7/06; C11D 7/12

(52) U.S. Cl. CPC C11D 7/06; C11D 7/12; C11D 2111/14

(57) ABSTRACT

The disclosure relates generally to methods for sanitizing dishware without conventional chemical sanitizing agents. The methods effectively sanitize dishware at low temperatures with an aqueous composition comprising alkali metal hydroxide.

### TECHNICAL FIELD

The disclosure relates generally to methods for sanitizing dishware. The methods effectively sanitize dishware at low temperatures with an aqueous composition comprising alkali metal hydroxide and without conventional chemical sanitizers.

### BACKGROUND

Methods of sanitizing dishware typically either include use of high temperatures, traditional chemical agents, and/or long sanitation times. Conventional low temperature dishware sanitation methods typically include traditional chemical sanitizers such as chlorine, iodine, and/or quaternary ammonium compounds. The use of high temperatures and traditional sanitizers present challenges such as operating cost and the impact of powerful sanitizing agents on the dishware and the persons handling the chemicals.

It is therefore an object of this disclosure to provide methods for sanitizing dishware at relatively low temperatures and without the use of traditional sanitizing agents.

Other objects, embodiments and advantages of this disclosure will be apparent to one skilled in the art in view of the following disclosure, the drawings, and the appended claims.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art and commercial methods, including by providing enhanced methods for low-temperature cleaning and sanitizing dishware without the use of traditional chemical sanitizers.

Disclosed herein is a low-temperature method of cleaning and sanitizing dishware comprising contacting dishware with an aqueous composition comprising greater than about 100 ppm alkali metal hydroxide for at least about 30 seconds at a temperature of less than about 70° C., and rinsing the dishware at a temperature less than about 70° C., wherein the aqueous composition is free of chlorine, iodine, and quaternary ammonium compounds. In an embodiment, the alkali metal hydroxide is sodium hydroxide. In an embodiment, the aqueous composition contacts the dishware for about 30 seconds to about 2 hours. In an embodiment, the aqueous composition further comprises an alkali metal carbonate. In an embodiment, the alkali metal carbonate is sodium carbonate. In an embodiment, the aqueous composition comprises from about 150 ppm to about 1,000 ppm sodium hydroxide, or from about 250 ppm to about 500 ppm. In an embodiment, the contacting is at a temperature of from about 50° C. to about 65° C., or from about 55° C. to about 60° C. In an embodiment, the aqueous composition comprises an additional functional ingredient. In an embodiment, the functional ingredient comprises a gluconate chelant and a water conditioning polymer.

Disclosed herein is a low-temperature method of sanitizing dishware, the method comprising soaking the dishware in an aqueous composition comprising greater than about 100 ppm alkali metal hydroxide for at least about 30 seconds at a temperature of less than about 70° C.; and optionally rinsing the dishware at a temperature less than about 70° C., wherein the aqueous composition is free of chlorine, iodine, and quaternary ammonium compounds. In an embodiment, the alkali metal hydroxide is sodium hydroxide. In an embodiment, the aqueous composition contacts the dishware for about 60 seconds to about 2 hours. In an embodiment, the aqueous composition further comprises an alkali metal carbonate. In an embodiment, the aqueous composition further comprises sodium carbonate. In an embodiment, the aqueous composition comprises from about 150 ppm to about 1,000 ppm alkali metal hydroxide, or from about 250 ppm to about 500 ppm alkali metal hydroxide. In an embodiment, the soaking is at a temperature of from about 50° C. to about 65° C., or from about 55° C. to about 60° C. In an embodiment, the aqueous composition comprises an additional functional ingredient. In an embodiment, the additional functional ingredient comprises a gluconate chelant and a water conditioning polymer.

In an embodiment, the methods described herein take place in a dish washing machine. In an embodiment, the methods described herein provide a greater than 4.0 log kill rate of polio. In an embodiment, the methods described herein provide a greater than 5.0 log kill rate of E. coli and S. aureus.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

The present disclosure is not to be limited to that described herein, which can vary and are understood by skilled artisans. No features shown or described are essential to permit basic operation of the present disclosure unless otherwise indicated.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, mass, volume, time, temperature, pH, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “exemplary” refers to an example, an instance, or an illustration, and does not indicate a most preferred embodiment unless otherwise stated.

For the purposes of this disclosure, the terms “dish,” and “ware” and/or “dishware” are used in the broadest sense to refer to various types of articles used in the preparation, serving, consumption, and disposal of food stuffs including pots, pans, trays, pitchers, bowls, plates, saucers, cups, glasses, forks, knives, spoons, spatulas, and other glass, metal, ceramic, plastic composite articles commonly available in the institutional or household kitchen or dining room. These types of articles can be referred to as food or beverage contacting articles because they have surfaces which are provided for contacting food and/or beverage.

As used herein, the term “free” refers to compositions completely lacking the component or having such a small amount of the component that the component does not affect the performance of the composition. The component may be present as an impurity or as a contaminant and shall be less than about 0.1 wt-% and in yet another embodiment, the amount of component is less than about 0.01 wt-%, or 0 wt-%.

The term “generally” encompasses both “about” and “substantially.”

The term “hard surface” refers to a solid, substantially non-flexible surface such as a counter top, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, food processing surfaces.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The scope of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “surfactant” or “surface active agent” refers to an organic chemical that when added to a liquid changes the properties of that liquid at a surface.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

According to embodiments, disclosed herein is a method for cleaning and sanitizing dishware and a method for sanitizing dishware. The methods include contacting the ware with an aqueous composition comprising at least about 100 ppm alkali metal hydroxide. In an embodiment, the methods include contacting the ware with more than about 100 ppm alkali metal hydroxide.

In an embodiment, the methods comprise contacting the ware with an aqueous composition comprising at least about 200 ppm alkali metal hydroxide, at least about 250 ppm alkali metal hydroxide, at least about 300 ppm alkali metal hydroxide, at least about 400 ppm alkali metal hydroxide, at least about 400 ppm alkali metal hydroxide, at least about 500 ppm alkali metal hydroxide, at least about 1,000 ppm alkali metal hydroxide, at least about 5,000 ppm alkali metal hydroxide, at least about 10,000 ppm alkali metal hydroxide, or at least about 40,000 ppm alkali metal hydroxide. In an embodiment, the methods comprise contacting the ware with an aqueous composition comprising from about 100 ppm to about 100,000 ppm alkali metal hydroxide, from about 200 ppm to about 50,000 ppm alkali metal hydroxide, from about 250 ppm to about 10,000 ppm alkali metal hydroxide, from about 250 ppm to about 5,000 ppm alkali metal hydroxide, from about 250 ppm to about 1,000 ppm alkali metal hydroxide, or from about 250 ppm to about 500 ppm alkali metal hydroxide. In addition, without being limited according to the disclosure, all ranges recited are inclusive of the numbers defining the range and include each integer within the defined range.

As used herein, “alkali metal hydroxide” refers to a compound composed of an alkali metal cation and a hydroxide anion. In an embodiment the alkali metal hydroxide comprises sodium hydroxide. In an embodiment, the alkali metal hydroxide is sodium hydroxide.

In an embodiment, the methods comprise contacting the ware with an aqueous composition as described herein for at least about 30 seconds, for at least about 60 seconds, for at least about 10 minutes, for at least about 30 minutes, for at least about 1 hour, for at least about 6 hours, for at least about 24 hours, for at least about 48 hours. In an embodiment, the methods comprise contacting the ware with an aqueous composition as described herein for about 30 seconds to about 48 hours, for about 30 seconds to about 24 hours, for about 30 seconds to about 6 hours, for about 30 seconds to about 2 hours, for about 30 seconds to about 1 hour, for about 60 seconds to about 1 hour, or for about 1 hour to about 6 hours. In an embodiment, the methods comprise contacting the ware with an aqueous composition as described herein for less than about 10 minutes, for less than about 5 minutes, for less than about 2 minutes, or for less than about 1 minute. In addition, without being limited according to the disclosure, all ranges recited are inclusive of the numbers defining the range and include each integer within the defined range.

In an embodiment, the methods described herein comprise contacting the dishware with an aqueous composition comprising alkali metal hydroxide at a temperature of less than about 100° C., less than about 80° C., less than about 70° C., less than about 60° C., less than about 55° C., less than about 50° C., less than about 45° C., less than about 40° C., less than about 35° C., less than about 30° C., or at ambient temperature. In an embodiment, the methods described herein comprise contacting the dishware with an aqueous composition comprising alkali metal hydroxide at a temperature of between about 1° C. to about 100° C., about 5° C. to about 80° C., about 1° C. to about 70° C., about 2° C. to about 70° C., about 5° C. to about 70° C., about 10° C. to about 70° C., about 20° C. to about 70° C., about 30° C. to about 70° C., about 40° C. to about 70° C., or about 50° C. to about 70° C., about 10° C. to about 60° C., about 20° C. to about 60° C., about 30° C. to about 60° C., about 40° C. to about 60° C., about 50° C. to about 60° C., or about 55° C. to about 60° C. In addition, without being limited according to the disclosure, all ranges recited are inclusive of the numbers defining the range and include each integer within the defined range.

In an embodiment, the aqueous composition comprising alkali metal hydroxide is substantially free of conventional sanitizing agents. In an embodiment, the aqueous composition comprising alkali metal hydroxide is free of conventional sanitizing agents. In an embodiment, the aqueous composition comprising alkali metal hydroxide is substantially free of chlorine, iodine, and/or quaternary ammonium compounds. In an embodiment, the aqueous composition comprising alkali metal hydroxide is free of chlorine, iodine, and/or quaternary ammonium compounds. In an embodiment, the methods as described herein are free of conventional sanitizing agents. In an embodiment, the methods as described herein are free of chlorine, iodine, and/or quaternary ammonium compounds.

In an embodiment, the methods described herein comprise rinsing the dishware after contacting the ware with the aqueous solution comprising alkali metal hydroxide. In an embodiment, the methods comprising rinsing the dishware at a temperature of less than about 80° C., less than about 70° C., less than about 60° C., less than about 55° C., less than about 50° C., less than about 45° C., less than about 40° C., less than about 35° C., less than about 30° C., or at ambient temperature. In an embodiment, the methods described herein comprise rinsing the dishware at a temperature of between about 1° C. to about 80° C., about 5° C. to about 70° C., about 10° C. to about 70° C., about 20° C. to about 70° C., about 30° C. to about 70° C., about 40° C. to about 70° C., about 50° C. to about 70° C., or about 60° C. to about 70° C. In addition, without being limited according to the disclosure, all ranges recited are inclusive of the numbers defining the range and include each integer within the defined range.

In an embodiment, the aqueous composition comprising alkali metal hydroxide further comprises an alkali metal carbonate. In an embodiment, the alkali metal carbonate comprises sodium carbonate. In an embodiment, the alkali metal carbonate is sodium carbonate. In an embodiment, the aqueous composition comprises at least about 10 ppm alkali metal carbonate, at least about 50 ppm alkali metal carbonate, at least about 100 ppm alkali metal carbonate, at least about 200 ppm alkali metal carbonate, at least about 500 ppm alkali metal carbonate, at least about 1,000 ppm alkali metal carbonate, at least about 5,000 ppm alkali metal carbonate, or at least about 10,000 ppm alkali metal carbonate. In an embodiment, the aqueous composition comprises from about 10 ppm to about 100,000 ppm alkali metal carbonate, from about 100 ppm to about 50,000 ppm alkali metal carbonate, from about 100 ppm to about 10,000 ppm alkali metal carbonate, from about 100 ppm to about 5,000 ppm alkali metal carbonate, from about 100 ppm to about 1,000 ppm alkali metal carbonate, from about 100 ppm to about 500 ppm alkali metal carbonate, or from about 100 ppm to about 200 ppm alkali metal carbonate. In addition, without being limited according to the disclosure, all ranges recited are inclusive of the numbers defining the range and include each integer within the defined range.

In an embodiment, the aqueous composition comprising alkali metal hydroxide further comprises an additional functional ingredient. The functional ingredients provide desired properties and functionalities to the compositions. For the purpose of this application, the term “functional ingredient” includes a material that provides a beneficial property in a particular use. In an embodiment, the aqueous composition further comprises builders, surfactants, polymers, solvents, water conditioning agents, metal protecting agents, enzymes, corrosion inhibitors, sequestrants and/or chelating agents, sheeting agents, pH modifying components, fragrances and/or dyes, hydrotropes or couplers, buffers, additional cleaning agents, and the like.

In an embodiment, the aqueous composition comprises a chelant. In an embodiment, the chelant comprises a carboxylate such as citrate, tartrate or gluconate. In an embodiment, the chelant comprises a gluconate chelant. In an embodiment, the chelant is a gluconate chelant.

In an embodiment, the aqueous composition comprises a water conditioning polymer. In an embodiment, the water conditioning polymer comprises a polycarboxylate homopolymer, copolymer and/or terpolymer. In an embodiment, the water conditioning polymer comprises homopolymers, copolymers and terpolymers of polyacrylates, polymethacrylates, and/or polymaleates. In an embodiment, the water conditioning polymers comprise acrylic acid homopolymers, maleic acid homopolymers, methacrylic acid homopolymers, acrylic/maleic copolymers, maleic acid copolymers, acrylic/methacrylic copolymers, maleic acid terpolymers, hydrophobically modified acrylic acid copolymers and terpolymers, hydrophobically modified maleic acid copolymers and terpolymers, hydrophobically modified methacrylic acid copolymers and terpolymers. In an embodiment, the water conditioning polymer comprises polyacrylic acid and/or polymaleic acid.

In an embodiment, the water conditioning polymer comprises a phosphonic acid. In an embodiment, the water conditioning polymer comprises an organic phosphonate and/or organic phosphonic acid. Organic phosphonates are organic derivatives of phosphonic acid, HP(O)(OH)₂. In an embodiment, the organic phosphonic acid comprises 1-hydroxyethylidene-1,1-diphosphonic acid (HEDP) and/or 2-phosphonobutane-1,2,4-tricarboxylic acid (PBTC).

Generally, organic phosphonates have one of the following structures:

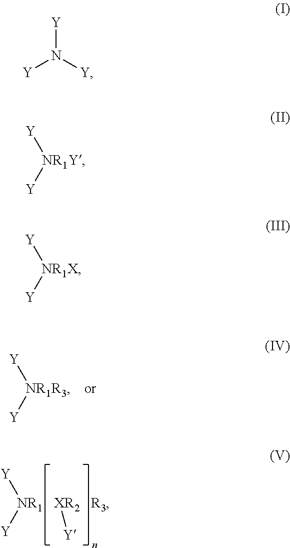

wherein:
Y is

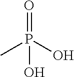

or a salt thereof;
Y′ is absent,

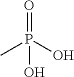

or a salt thereof;
X is N, O, or OH;
R₁ and R₂ are independently a linear or branched C1-C10 alkyl group;
R₃ is —N(Y)₂; and
n is 1-20.

In the structures I-V the salt form of Y or Y′ is preferably a suitable cation, such as sodium or potassium.

In an embodiment, the organic phosphonates comprise polyether phosphonic acids, including polyamino polyether methylene phosphonic acid and polyamino polyether methylene phosphonates such as the those having the following structure:

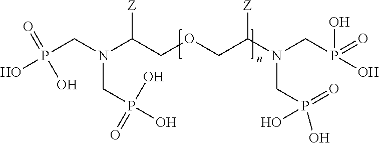

wherein Z is independently H or CH₃, and wherein n is 2-12. In a preferred embodiment the organic phosphonate is PAPEMP ((HO)₂P(O)CH₂)₂NCH(CH₃)CH₂(OCH₂CH(CH₃)₂N(CH₂)₆N(CH₂P(O)(OH)₂)₂) having the structure:

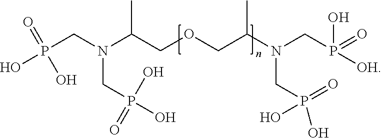

Additional exemplary organic phosphonates include the structures:

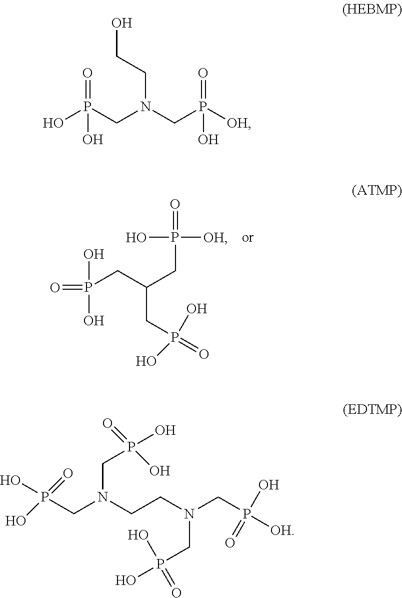 [SMILES: O=P(O)(O)CN(CCO)CP(=O)(O)O ; O=P(O)(O)CC(CP(=O)(O)O)CP(=O)(O)O ; O=P(O)(O)CN(CCN(CP(=O)(O)O)CP(=O)(O)O)CP(=O)(O)O]

Still further exemplary organic phosphonates include HMDTMP ((HO)₂P(O)CH₂)₂N(CH₂)₆N(CH₂2P(O)(OH)₂)₂) having the structure:

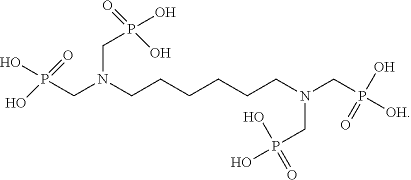 [SMILES: O=P(O)(O)CN(CCCCCCN(CP(=O)(O)O)CP(=O)(O)O)CP(=O)(O)O]

and the like.

Still further exemplary organic phosphonates include DTMPA ((HO)₂P(O)CH₂N[CH₂CH₂N(CH₂P(O)(OH)₂)₂]₂) having the structure:

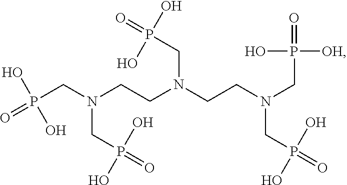 [SMILES: O=P(O)(O)CN(CCN(CP(=O)(O)O)CP(=O)(O)O)CCN(CP(=O)(O)O)CP(=O)(O)O]

In an embodiment, the aqueous composition comprises from about 10 ppm to about 100,000 ppm additional functional ingredients, from about 100 ppm to about 50,000 ppm additional functional ingredients, from about 100 ppm to about 10,000 ppm additional functional ingredients, from about 100 ppm to about 5,000 ppm additional functional ingredients, from about 100 ppm to about 1,000 ppm additional functional ingredients, from about 100 ppm to about 500 ppm additional functional ingredients, or from about 100 ppm to about 200 ppm additional functional ingredients. In addition, without being limited according to the disclosure, all ranges recited are inclusive of the numbers defining the range and include each integer within the defined range.

In an embodiment, the methods as described herein are carried out in any vessel as known in the art, for example a sink, tub, dishwashing machine, industrial dishwashing machine, and the like. In an embodiment, the methods as described herein are conducted in a dishwashing machine. In an embodiment, the methods as described herein may be carried out in any consumer or institutional dish machine. Some non-limiting examples of dish machines include door machines or hood machines, conveyor machines, undercounter machines, glasswashers, flight machines, pot and pan machines, utensil washers, and consumer dish machines. The dish machines may be either single tank or multi-tank machines.

A door dish machine, also called a hood dish machine, refers to a commercial dish machine wherein the soiled dishes are placed on a rack and the rack is then moved into the dish machine. Door dish machines clean one or two racks at a time. In such machines, the rack is stationary and the wash and rinse arms move. A door machine includes two sets arms, a set of wash arms and a rinse arm, or a set of rinse arms. The door machine may either be a recirculation machine or a dump and fill machine. In a recirculation machine, the detergent solution is reused, or “recirculated” between wash cycles. The concentration of the detergent solution is adjusted between wash cycles so that an adequate concentration is maintained. In a dump and fill machine, the wash solution is not reused between wash cycles. New detergent solution is added before the next wash cycle.

In an embodiment, the aqueous composition comprising alkali metal hydroxide contacts the dishware by any method as known in art, including but not limited to spraying the aqueous composition, immersing the dishware in the aqueous composition, soaking the dishware in the aqueous composition, wiping the aqueous composition onto the dishware, and/or flowing the aqueous composition over the dishware. Contacting can be manual or by machine. In an embodiment, contacting comprises scrubbing.

In an embodiment, the methods as described herein comprise soaking the dishware in an aqueous composition as described herein.

In an embodiment, the methods as described herein provide a greater than 3.0 log kill rate of polio, greater than 4.0 log kill rate of polio, or greater than 5.0 log kill rate of polio.

In an embodiment, the methods as described herein provide a greater than 3.0 log kill rate of E. coli, greater than 4.0 log kill rate of E. coli, or greater than 5.0 log kill rate of E. coli.

In an embodiment, the methods as described herein provide a greater than 3.0 log kill rate of S. aureus, greater than 4.0 log kill rate of S. aureus, or greater than 5.0 log kill rate of S. aureus.

In an embodiment, the methods as described herein provide a greater than 3.0 log kill rate of C. albicans, greater than 4.0 log kill rate of C. albicans, or greater than 5.0 log kill rate of C. albicans.

In an embodiment, the methods as described herein provide a greater than 3.0 log kill rate of A. niger, greater than 4.0 log kill rate of A. niger, or greater than 5.0 log kill rate of A. niger.

In an embodiment, the methods as described herein provide a greater than 3.0 log kill rate of B. subtilis spores, greater than 4.0 log kill rate of B. subtilis spores, or greater than 5.0 log kill rate of B. subtilis spores.

In an embodiment, the methods as described herein provide a greater than 3.0 log kill rate of P. aeruginosa, greater than 4.0 log kill rate of P. aeruginosa, or greater than 5.0 log kill rate of P. aeruginosa.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

This example contains comparative data showing the state of the art. Table 1 contains data from a 2001 publication titled Use of Sodium Hydroxide for Cleaning and Sanitization of Chromatography Resins and Systems by General Electric.

TABLE 1

| Organism | NaOH (M) | NaOH (ppm) | Time | | Temp (° C.) |
|---|---|---|---|---|---|
| E. coli | 0.01 | 400 | 2 | hours | 4 or 22 |
| S. aureus | 0.1 | 4,000 | 1 | hour | 4 or 22 |
| C. albicans | 0.5 | 20,000 | 1 | hour | 4 or 22 |
| A. niger | 0.5 | 20,000 | 1 | hour | 4 or 22 |
| B. subtilis | 1.0 | 40,000 | 48 | hours | 22 |
| spores | | | | | |
| B. subtilis | 1.0 | 40,000 | 8 | days | 4 |
| spores | | | | | |
| P. aeruginosa | 0.5 | 20,000 | 1 | hour | 22 |

Table 1 outlines the time it takes for reduction of the organism below the detection limit of less than 3 organisms/mL, with the exception of B. subtilis spores wherein the detection limit is 10 organisms/mL for the first entry in Table 1 and less than 100 organisms/mL for the second entry. As can be seen from Table 1, at a low temperature of either 4° C. or 22° C., relatively large concentrations of NaOH for an hour or more are required for adequate sanitation effectiveness.

### Example 2

The efficacy of sodium hydroxide as a sanitizer at different concentrations was evaluated. The evaluation was conducted with aqueous formulations containing 100 ppm sodium hydroxide, 250 ppm sodium hydroxide, and 500 ppm sodium hydroxide at a temperature of 60° C., wherein the formulations contacted the polio virus for 60 seconds. The results for killing the polio virus are outlined in Table 2.

TABLE 2

| NaOH | | | |
|---|---|---|---|
| Concentration | Time | Temperature | Polio Kill Rate |
| 100 ppm | 60 seconds | 60° C. | 0 |
| 250 ppm | 60 seconds | 60° C. | ≥4 log |
| 500 ppm | 60 seconds | 60° C. | ≥4 log |

As shown in Table 2, a solution of 100 ppm sodium hydroxide at 60° C. does not kill polio after 60 seconds. Formulations of 250 ppm and 500 ppm sodium hydroxide both successfully killed the polio virus after 60 seconds at 60° C.

### Example 3

A formulation comprising NaOH, sodium gluconate, PBTC, and polyacrylic acid was diluted in water for a NaOH concentration of about 500 ppm. This formulation was found to have a polio virus kill rate of ≥4 log after 60 seconds at 55° C.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A low-temperature method of cleaning and sanitizing dishware, the method comprising:
contacting the dishware with an aqueous composition comprising greater than about 100 ppm alkali metal hydroxide for at least about 30 seconds at a temperature of less than about 70° C.; and
rinsing the dishware at a temperature less than about 70° C.,
wherein the aqueous composition is free of chlorine, iodine, and quaternary ammonium compounds.

2. The method of claim 1, wherein the alkali metal hydroxide is sodium hydroxide.

3. The method of claim 1, wherein the aqueous composition further comprises an alkali metal carbonate.

4. The method of claim 3, wherein the alkali metal carbonate is sodium carbonate.

5. The method of claim 1, wherein the aqueous composition comprises from about 150 ppm to about 1000 ppm alkali metal hydroxide, and wherein the contacting is a temperature of from about 50° C. to about 65° C.

6. The method of claim 1, wherein the aqueous composition comprises from about 250 ppm to about 500 ppm alkali metal hydroxide, and wherein the contacting is at a temperature of from about 55° C. to about 60° C.

7. The method of claim 1, wherein the aqueous composition comprises an additional functional ingredient selected from the group consisting of builders, surfactants, polymers, solvents, water conditioning agents, metal protecting agents, enzymes, corrosion inhibitors, sequestrants and/or chelating agents, sheeting agents, pH modifying components, fragrances and/or dyes, hydrotropes or couplers, buffers, and combinations thereof.

8. The method of claim 7, wherein the aqueous composition further comprises a gluconate chelant and a water conditioning polymer.

9. The method of claim 1, wherein the method takes place in a dish washing machine.

10. The method of claim 1, wherein the aqueous composition contacts the dishware for about 30 seconds to about 2 hours.

11. The method of claim 1, wherein the method provides a greater than 4.0 log kill rate of polio.

12. The method of claim 1, wherein the method provides a greater than 5.0 log kill rate of E. coli and S. aureus.

13. A low-temperature method of sanitizing dishware, the method comprising:
soaking the dishware in an aqueous composition comprising greater than about 100 ppm alkali metal hydroxide for at least about 30 seconds at a temperature of less than about 70° C.; and
optionally rinsing the dishware at a temperature less than about 70° C.,
wherein the aqueous composition is free of chlorine, iodine, and quaternary ammonium compounds.

14. The method of claim 13, wherein the alkali metal hydroxide is sodium hydroxide.

15. The method of claim 13, wherein the aqueous composition further comprises sodium carbonate.

16. (canceled)

17. The method of claim 13, wherein the aqueous composition comprises from about 150 ppm to about 1000 ppm alkali metal hydroxide, and wherein the soaking is at a temperature from about 50° C. to about 65° C.

18. (canceled)

19. The method of claim 13, wherein the aqueous composition comprises an additional functional ingredient selected from the group consisting of builders, surfactants, polymers, solvents, water conditioning agents, metal protecting agents, enzymes, corrosion inhibitors, sequestrants and/or chelating agents, sheeting agents, pH modifying components, fragrances and/or dyes, hydrotropes or couplers, buffers, and combinations thereof.

20. The method of claim 19, wherein the aqueous composition further comprises a gluconate chelant and a water conditioning polymer.

21. The method of claim 13, wherein the aqueous composition contacts the dishware for about 60 seconds to about 2 hours.

22. The method of claim 13, wherein the method provides a greater than 4.0 log kill rate of polio.
